(19) United States
(12) Patent Application Publication
(10) Pub. No.: US 2008/0201513 A1
(43) Pub. Date: Aug. 21, 2008

(54) Method and Device to Transfer Digital Data

(76) Inventors: Assaf Waisler, Rechovot (IL); Alon Lahav, Petach Tikwa (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, omitted

(21) Appl. No.: 12/033,900

(22) Filed: Feb. 20, 2008

Related U.S. Application Data
(60) Provisional application No. 60/902,032, filed on Feb. 20, 2007.
(60) Provisional application No. 60/928,198, filed on May 9, 2007.

(51) Int. Cl. G06F 13/14

(52) U.S. Cl. 710/305

(57) ABSTRACT

Transfer digital data to and from a digital source from and to a digital storage device without using an intermediary media like a computer. Digital source includes digital storage devices and digital transmitting devices like televisions, videos and radios. Digital storage devices includes disc-on-keys, other portable hard disks, PDA's, MP3, MP4, digital cameras, and the like. Non-portable digital source examples are bank information booths and car park entry barriers. Screen to show memory content. Means to see contents of memory and move, copy, paste, delete files from and to the digital memory. Voice recognition operation.

### PRIORITY

This application claims the priority of the following two provisional applications:

Application No. 60/902,032 filed on Feb. 20, 2007
Application No. 60/928,198 filed on May 9, 2007.

### FIELD OF THE INVENTION

This invention is in the field of digital electronics and more particularly enabling one digital instrument to transfer stored digital information to another digital instrument without the need of a computer as an intermediary.

### BACKGROUND OF THE INVENTION

There are many kinds of digital instruments today that can create digital files and store them in a digital memory. Examples are USB flash drives, PDA hand held computers, MP3 and MP4, Digital cameras, Cellular phones, DVD, VCR and the like. Digital data can also be created from transmitted data like for example television or radio.

The method usually used to transfer digital data from one such instrument to another being of the same kind or sometimes of a different kind, for example, digital camera to MP3, is by using a computer as an intermediary.

This invention reveals a method to transfer data direct from one digital instrument to another without using a computer as an intermediary. Other aspects are also revealed like ability to see the files currently in the memory, ability to mark, examine contents, copy, paste, transfer or delete files.

Voice recognition technology could be used to give instructions. The range of possible instructions would be relatively small making the device more compatible with voice recognition technology.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

This invention reveals a method to transfer digital data from one instrument to another instrument without needing to attach to a computer. The said data could be any kind of data including text, spreadsheet, pictures, video and music. The invention includes hardware to enable two or more digital instruments to connect to each other via for example USB connections. These connections could be direct from instrument to instrument or using an intermediary device to connect into or using cables and connectors. There could also be a screen to aid and ease knowing what files are in the transferor instrument and to aid choosing the file to transfer to the transferee instrument. The user could see a list of files in memory, carry out a search for a file, open a specific file to examine its content, copy or transfer a file or files to another instrument attached or delete files. Additional application of this invention is transfer of digital television programs, videos or radio programs to a disk-on-key, MP3 or similar instruments of digital data for storage or transfer to a transferee digital instrument.

A further application is where the source of digital data is not portable like for example a bank account information point where a customer could insert his disk-on-key or PDA to a connection point in such an information point to download the customer's bank statements and other information available to authorized customers. The user would then have a copy of the transferred account transactions and details for perusal on the screen of the target data device.

The invention could also be applied to authorization entry to authorized individuals for example a person who paid a subscription to a car park could enter his disk-on-key to an appropriate connector at the entrance to gain access to the car park. The user's password code would be stored in his disk-on-key and then accessed by the car park authorization stand before opening the entrance gates. The same could apply to entrance to buildings where only authorized personnel may enter.

There could be knobs and buttons to assist this inspection and transfer process.

The invention also includes software to enable the user to view the files in the transferor instrument, choose the ones he wishes to transfer, choose the transferee instrument, where more than one is connected, and to send the desired files to the transferee instrument.

The transfer could also be done using infra-red or other wireless technology.

There could be a source of energy for example a battery and a software program to carry out the tasks herein described.

A further feature of this invention is to have a microphone to be able to give verbal instruction to the device of this invention to perform the instructions herein mentioned or with the appropriate support software, to write text in files stored in the memory of either the transferor or transferee instrument.

Another object of this invention is to see on a screen of the device of this invention, the files in the memory of the transferor instrument, read selected files, copy, paste, transfer, mark or delete files. A mouse-type button, pad or roller could be used to facilitate such operations.

Another object of this invention is for the above mentioned operations like for example copy, paste and so on could be given vocally using vocal and voice recognition technology. In addition such vocal and voice recognition technology could be used to “write” electronically on files and give other instructions.

This invention reveals a digital data transfer device including a source of digital data with a first connector member, a portable target of digital data with a second connector member where the first and second connector members connect to each other in order to transfer digital data and a screen in the target of digital data that enables browsing visually the contents of the source of digital data, and dedicated software in the said target digital data to identify and transfer the identified data from the said source digital data to the said target digital data.

Another embodiment of this invention is the digital data transfer device that includes a portable source of digital data with a first connector member, a portable target of digital data with a second connector member and a transfer device that connects to the first connector member and to the second connector member. There is also a screen in the transfer device that enables browsing visually the contents of the source of digital data and dedicated software in the transfer device to identify and transfer the identified source digital data from the source of digital data to the target of digital data.

The present invention also reveals a method of transferring digital data including the following steps, namely, connecting a portable source of digital data to a portable target of digital data, identifying the digital data to be transferred, using dedicated software, and transferring the data to the target of digital data, using the dedicated software.

An alternative method of transferring digital data including the following steps, namely, connecting a portable source of digital data to a portable digital transfer device, connecting the target of digital data to the portable digital transfer device, identifying the digital data to be transferred, using a screen and dedicated software and transferring the data from the source of digital data to the target of digital data, using the dedicated software.

The source of digital data could be stored in at least one of the following group namely, a disc-on-key, portable hard disc, MP3, MP4, portable notepad and PDA, bank account information point. The portable data target device could be at least one of the following group namely, a disc-on-key, portable hard disc, MP3, MP4, portable notepad and PDA. The connecting member could be a USB connector.

The transfer device could be a body with a screen and hardware to operate an operating system and dedicated software into which is connected to the source digital data and to the target digital data.

The portable source of digital data could be transmitted television and radio programs or could be a bank account information point where a customer of the bank wishes to take with him, in digital form, his bank account details. The customer would insert the smart disk-on-key to a connection in the bank information point and after entering a password his could transfer details from his account to the disk-on-key. Where the disk-on-key has a screen as anticipated by this invention the transferred detail could be examined by the customer remotely from the bank. Particularly in an example of use at a bank information point, browsing in the source digital data is limited to specific portions of the source of digital data and conditional upon user authorization by use of a password.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a schematic depiction of a standard prior art disk-on-key.

FIG. 2 is a schematic depiction of an embodiment of the disk-on-key of this invention.

FIG. 3 is a schematic depiction of a device of this invention that acts as the intermediary between two digital instruments where the said instruments have USB connectors to attach to the said device of this invention.

FIG. 4 is a schematic depiction of a device of this invention that acts as the intermediary between two digital instruments where the connection is with cables.

FIG. 5 is a schematic depiction of a direct connection between digital instruments.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

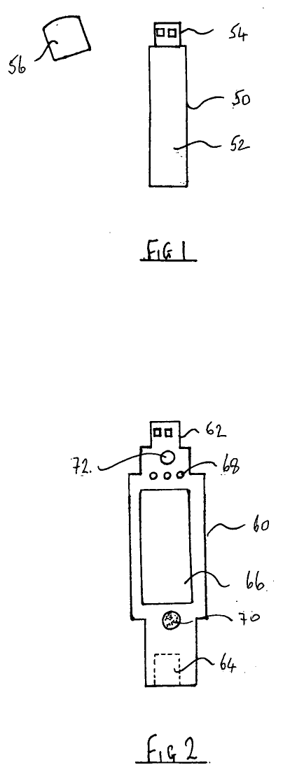

FIG. 1 shows a prior art disk-on-key 50 that is generally with a plastic or metal covering 52. The connections are made with the USB connector 54 and often there is a lid 56 for protection purposes.

FIG. 2 shows the disk-on-key 60 of this invention. The side with the male USB connection 62 is the same as the prior art USB connection FIG. 1 54. At the far end of the body of the disk-on-key 60 is the “female” USB connection 64. The “male” connection of another disk-on-key would fit into this “female” connection 64 in order to make the connection anticipated in this invention.

The disk-on-key 60 could be used to transfer digital data from itself 60 to another disk-on-key that is connected to the connection 64 or to transfer data from the other disk-on-key to itself 60. The display on the screen could be the contents of the memory of the disk-on-key 60 or the contents of the memory of the disk-on-key connected at the connection 64. The appropriate software enables the transfer of the chosen data from one disk-on-key to the other.

On the body of the key 60 is a screen 66 and controlling buttons 68 where one of the buttons 70 could be a rolling device to act as a “mouse”. The mouse button 70 could be used to mark certain files that are seen on the screen 66 in order to give the further instruction like, transfer, open, delete and so on. The buttons 68 would be used for these various functions. A microphone 72 could be used to accept vocal instructions instead of, or in conjunction with, the buttons 68 and to dictate text to a file and the like, when supported by the appropriate software.

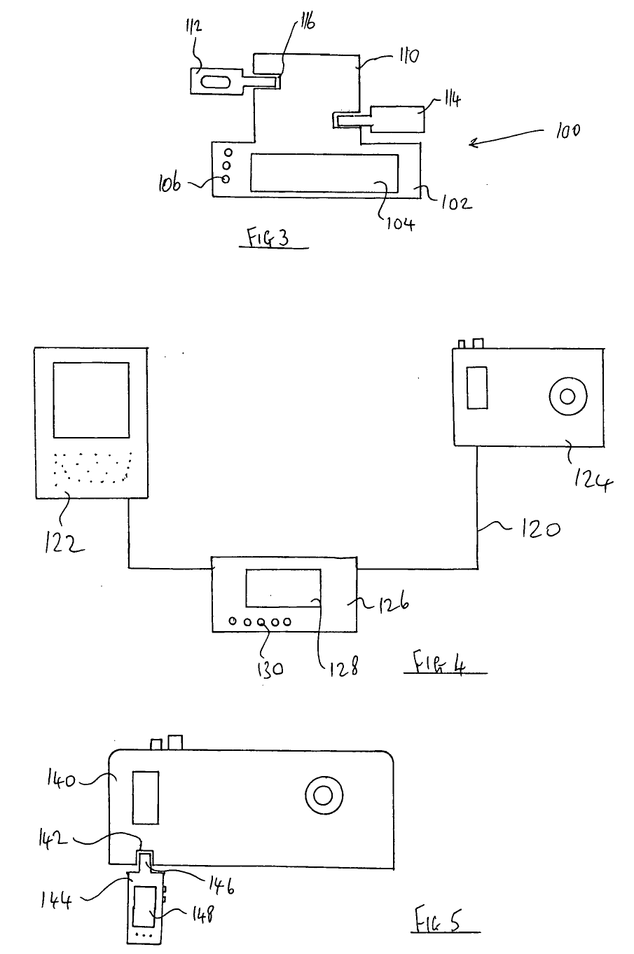

FIG. 3 shows another embodiment of this invention comprising a body 102 containing a micro-processor and software to carry out the functions herein mentioned and a screen 104 to see the menus, files and other data from the transferor 112 and/or the transferee 114 instruments. There could be buttons 106 to operate the functions of the device 100 one of which could be a function like a computer “mouse”.

The device 100 has a section 110 that houses at least one connection for the transferor instrument 112 and the transferee instrument 114. This connection could be a USB 116 connection or other appropriate connection depending on the instruments used and current technology.

The advantage of this embodiment is that neither the transferor 112 instrument nor the transferee 114 instrument needs special technology. Both instruments could be prior art disk-on-keys. In FIG. 2 at least one of the two instruments had to be the smart type disc-on key of this invention.

FIG. 4 shows two digital instruments that do not have USB connectors but do have the ability to have a cable connection 120. One instrument could be a PDA (personal digital assistant) 122 and the other could be a camera 124. The operational part of the device 126 could be similar to that described in FIG. 3 namely the micro-processor, software, screen and operating buttons.

The user could, for example, display on the screen 128 the files of photographs taken by and stored in the memory of camera 124. He could view the photos by opening the file and mark the photos he wants to copy with the aid of the buttons 130. He could then copy or transfer those files, using the buttons 130, to the PDA 122. Transfers could be effected in either direction. One of those buttons 130 could be a microphone to accept verbal instruction in the case of voice recognition technology.

FIG. 5 shows a situation where one instrument 140 has for example, a female connection 142 as an integral part of the instrument 140 and the other instrument 144 has a male connection 146 that fits into the connection 142. These connections could be USB connections or whatever manufactures use from time to time as connecting devices between digital instruments.

In this embodiment one of the said instruments contains the micro-processor, software, screen and control buttons. FIG. 5 shows a camera 140 and a “smart” disk-on-key 144. The disk-on-key screen 148 could display the contents of the digital memory of camera 140 and choose which files to transfer to its memory.

What is claimed:

1. Digital data transfer comprising,
a. a source of digital data with a first connector member,
b. a portable target of digital data with a second connector member where the first and second said connector members connect to each other in order to transfer digital data,
c. a screen in the said target of digital data that enables browsing visually the contents of the said source of digital data, and
d. dedicated software in the said target digital data to identify and transfer the identified data from the said source digital data to the said target digital data.

2. A digital data transfer device comprising,
a. a portable source of digital data with a first connector member,
b. a portable target of digital data with a second connector member,
c. a transfer device that connects to the said first connector member and to the second connector member,
d. a screen in the said transfer device that enables browsing visually the contents of the said source of digital data, and
e. dedicated software in the said transfer device to identify and transfer the identified source digital data from the said source of digital data to the said target of digital data.

3. A method of transferring digital data comprising the following steps, namely,
a. connecting a portable source of digital data to a portable target of digital data,
b. identifying the digital data to be transferred, using dedicated software,
c. transferring the said data to the said target of digital data, using the said dedicated software.

4. A method of transferring digital data comprising the following steps, namely,
a. connecting a portable source of digital data to a portable digital transfer device,
b. connecting the target of digital data to the said portable digital transfer device,
c. identifying the digital data to be transferred, using a screen and dedicated software,
d. transferring the said data from the source of digital data to the said target of digital data, using the said dedicated software.

5. A digital data transfer device as claimed in claim 1 wherein the source of digital data is stored in at least one of the following group namely, a disc-on-key, portable hard disc, MP3, MP4, portable notepad and PDA, bank account information point.

6. A digital data transfer device as claimed in claim 1 wherein the portable data target device is at least one of the following group namely, a disc-on-key, portable hard disc, MP3, MP4, portable notepad and PDA.

7. A digital data transfer device as claimed in claim 1 wherein the said connecting member is a USB connector.

8. A digital data transfer device as claimed in claim 1 wherein the said transfer device is a body with a screen and hardware to operate n operating system and dedicated software into which is connected the said source digital data and the said target digital data.

9. A digital data transfer device as claimed in claim 3 wherein the said portable source of digital data is transmitted television and radio programs.

10. Digital data transfer as claimed in claim 1 wherein the source of digital data is a bank account information point.

11. Digital data transfer as claimed in claim 1 wherein the said source of digital data is portable.

12. Digital data transfer as claimed in claim 1 wherein the said browsing is limited to specific portions of the said source of digital data and conditional upon user authorization by use of a password.

13. A method of transferring digital data as claimed in claim 3 comprising the further step of requiring entry of the user password.
